(19) United States
(12) Patent Application Publication
(10) Pub. No.: US 2013/0054506 A1
(43) Pub. Date: Feb. 28, 2013

(54) METHOD AND DEVICE FOR CONTROLLING AN INDUSTRIAL SYSTEM

(71) Applicants: Thomas Hubauer, Muenchen (DE); Steffen Lamparter, Muenchen (DE)

(72) Inventors: Thomas Hubauer, Muenchen (DE); Steffen Lamparter, Muenchen (DE)

(73) Assignee: SIEMENS AKTIENGESELLSCHAFT, MUENCHEN (DE)

(21) Appl. No.: 13/642,971

(22) PCT Filed: Apr. 18, 2011
(86) PCT No.: PCT/EP2011/056122

§ 371 Date: Oct. 23, 2012

(30) Foreign Application Priority Data
Apr. 23, 2010 (EP) 10004355.3

(51) Int. Cl. G06N 5/02

(52) U.S. Cl. 706/47

(57) ABSTRACT

A tractable abduction procedure for a lightweight description logic EL is introduced extending recent research on automata-based axiom pinpointing by assuming information from a predefined abducible part of the domain model. The approach is motivated by the need for efficient diagnostic reasoning for large-scale industrial systems where observations are partially incomplete and often sparse. A weighted automaton can be constructed that commonly encodes a definite and abducible part of the domain model. Advantageously, the approach provides a compact representation of all possible hypotheses explaining an observation, and is in fact computable in PTIME. The procedure can be used for controlling, adjusting or diagnosing all kinds of technical systems, in particular in the area of industry and automation.

The invention relates to a method and to a device for controlling an industrial system. Also, a system comprising at least one such device is suggested.

Abductive reasoning is a method for generating hypotheses that explain an observation based on a model of the domain, typically in the presence of incomplete data. Its non-monotonicity and explorative nature make abduction a promising candidate for an interpretation of potentially incomplete information—a task which is much harder to accomplish using established monotonic inference methods such as deduction or the more elaborate axiom pinpointing.

The applications of abductive inference are diverse, ranging from text interpretation according to [Hobbs1993] to plan generation and analysis according to [Appelt1992], and interpretation of sensor or multimedia data according to [Shanahan2005] or [Peraldi2007].

The problem to be solved is to provide an efficient mechanism for abductive inference that enables a compact representation of hypotheses explaining an observation and is computable in a polynomial amount of time.

This problem is solved according to the features of the independent claims. Further embodiments result from the depending claims.

In order to overcome this problem, a method controlling an industrial system is provided,
wherein a pattern-based definition of abducibles is determined;
wherein an abduction problem is solved based on the pattern-based definition of abducibles.

The pattern allows restricting the number of abducibles and thus the search space for, e.g. hypotheses to be generated. This increases efficiency and in particular feasibility of controlling the industrial system, e.g., in real-time.

In an embodiment, the abduction problem is denoted as

[symbol]

=( [symbol] ,A₀ [symbol] B₀,Pat,ν^{C},rng)
with
   [symbol] an EL-TBox over concept names N_{C} and role names N_{R},
   A₀ [symbol] B₀ a general concept inclusion in normal form such that A₀, B₀εN_{C} (called an observation)
   ν^{C} a set of concept variables,
   Pat a set of axiom patterns over ν^{C} whose size is polynomially bounded by the number of concept names in N_{C},
   rng a range function.

In another embodiment, the pattern-based definition of abducibles comprises a set of abducibles containing all axioms generated by normalizing the elements of the set of axiom patterns and instantiating them with concept names from the range, omitting axioms already contained in the EL-Tbox.

In a further embodiment, each abducible in the set of abducibles is labeled with a unique propositional variable.

In a next embodiment, each axiom in the EL-Tbox and each abducible in the set of abducibles is labeled with a unique propositional variable, respectively, such that the sets of axiom labels and abducible labels are disjoint.

It is also an embodiment that hypotheses are determined as formula over all labels occurring in the abduction problem such that for all valuations the following applies:

ν [symbol] η [symbol] iff [symbol] _{ν} [symbol] A₀ [symbol] B₀
with
   ν⊂lab( [symbol] ) valuations,
   lab( [symbol] ) labeling function denoting a set of all labels occurring in the abduction problem,
   η [symbol] hypotheses formula.

Pursuant to another embodiment, the abduction problem is solved via a weighted automaton.

According to an embodiment, the abduction problem is solved via a weighted Büchi automaton

[symbol]

={Q,wt,in,F}
over binary trees with
   Q={(A, B), (A, r, B)|A, BεN_{C′}∪{T}, rεN_{R};
   ∀A, B, B₁, B₂εN_{C′}∪{T}, ∀rεN_{R};
      wt((A, B), (A, B₁), (A, B₂)=lab(B₁ [symbol] B₂ [symbol] B);
      wt((A, r, B), (A, B₁), (A, A)=lab(B₁ [symbol] ∃r·B);
      wt((A, B), (A, r, B₁), (B₁, B₂)=lab(∃r·B₂ [symbol] B);
      wt((q₁, q₂, q₃)=⊥ for all other q₁, q₂, q₃εQ;
   in(q)=T iff q=(A₀, B₀), otherwise in(q)=⊥, and
   F={(A, A)|AεN_{C′}∪{T}},
with
   Q a set of states,
   F⊂Q a set of terminal states,
   in an initial distribution,
   wt transition weights of the Büchi automation [symbol] .
   N_{C′} a set of concept names N_{C} extended by new concept names introduced during normalization.

According to another embodiment, the industrial system is at least partially described by a description logic, in particular one of a lightweight description logic family.

Hence, EL, EL⁺ or EL⁺⁺ can be used as a description logic.

In yet another embodiment, said controlling comprises diagnosing, adjusting, accessing or setting parameters of said industrial system.

According to a next embodiment, said industrial system comprises at least one of the following:
a machine,
a factory,
an assembly or production line,
a manufacturing site
an industrial application.

The problem stated above is also solved by a device for controlling an industrial system, comprising or being associated with a processing or controlling unit that is arranged
for determining or interpreting a pattern-based definition of abducibles;
for solving an abduction problem based on the pattern-based definition of abducibles.

The problem is in particular solved by a device comprising a controlling unit that is arranged such that the (steps of the) method described herein (are) is executable thereon

It is further noted that said processing unit (or controlling unit) can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

According to an embodiment, the device is a control device of the industrial system.

According to another embodiment, the device is connected to the industrial system via a network, in particular via the Internet.

Furthermore, the problem stated above is solved by a system comprising at least one device as described herein.

Embodiments of the invention are shown and illustrated in the following figure:

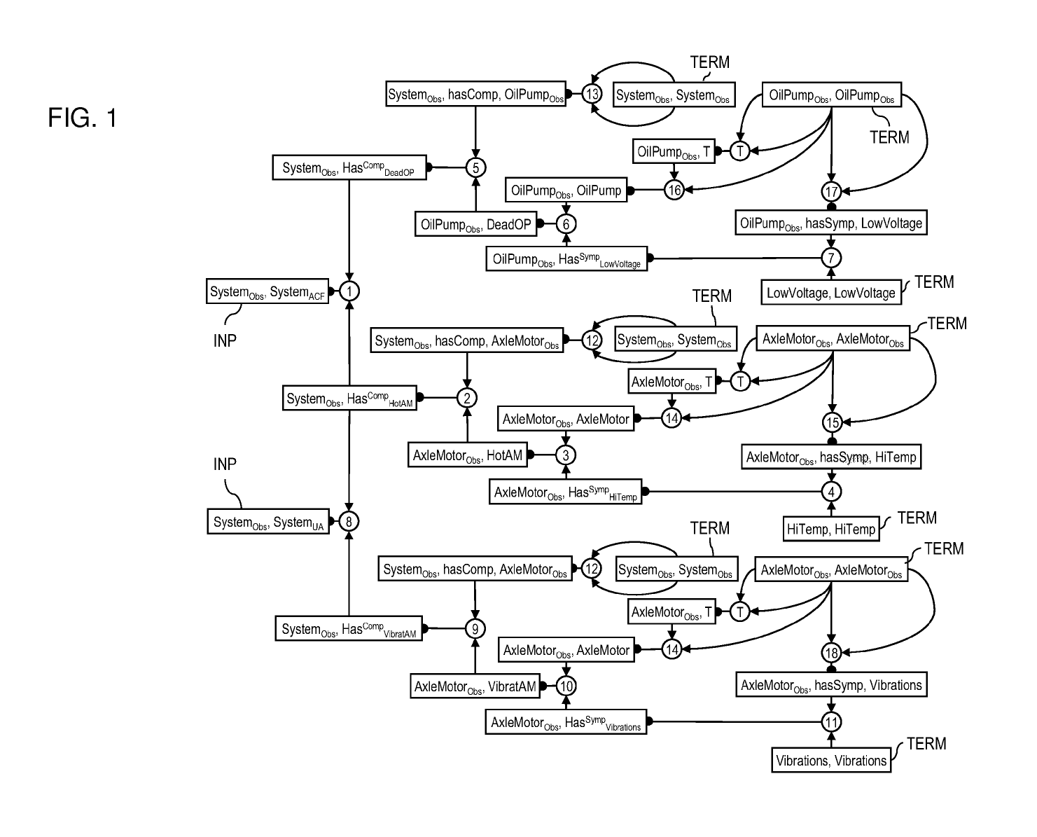

FIG. 1 shows an excerpt containing one successful run for each diagnosis to solve an exemplary abduction problem;

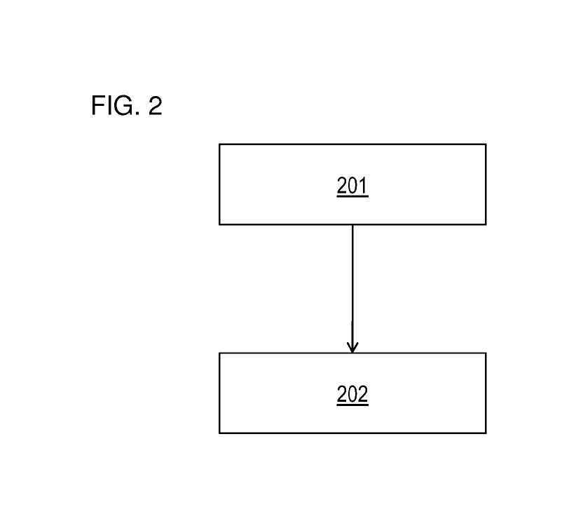

FIG. 2 shows steps of a method to solve an abduction problem using a pattern-based definition;

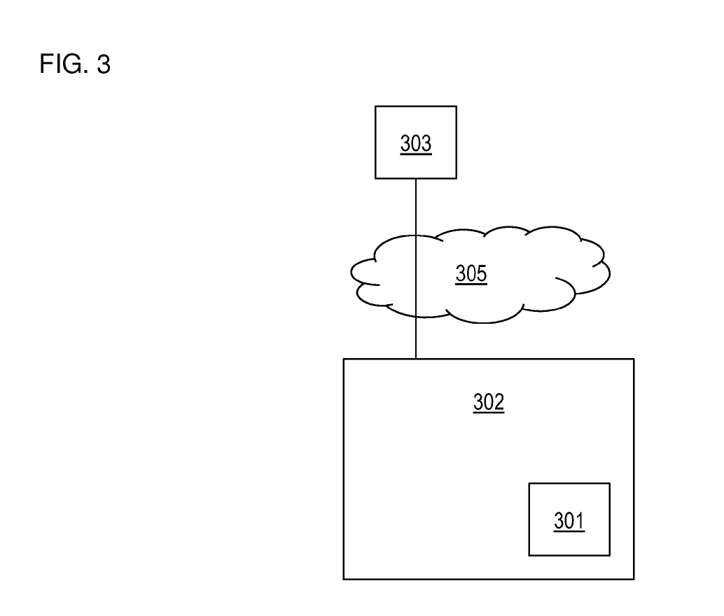

FIG. 3 shows a device for controlling an industrial system.

Abductive reasoning has been recognized as a valuable complement to deductive inference for tasks such as diagnosis and integration of incomplete information despite its inherent computational complexity.

Herewith, a novel, tractable abduction procedure for a lightweight description logic EL is introduced. The proposed approach extends recent research on automata-based axiom pinpointing (which is in some sense dual to the current problem) by assuming information from a predefined abducible part of the domain model if necessary, while the remainder of the domain is considered to be fixed. The approach is motivated by the need for efficient diagnostic reasoning for large-scale industrial systems where observations are partially incomplete and often sparse. However, the largest part of the domain such as physical structures is known.

Technically, a novel pattern-based definition of abducibles is introduced and it will be shown how to construct a weighted automaton that commonly encodes the definite and abducible parts of the domain model. Its behavior provides a compact representation of all possible hypotheses explaining an observation, and is in fact computable in PTIME.

In computational complexity theory, P, also known as PTIME or DTIME(n^{O(1)}), is a fundamental complexity class that contains all decision problems which can be solved by a deterministic Turing machine using a polynomial amount of computation time, or polynomial time.

The approach presented herein in particular relates to abductive inference and is for example motivated by industrial applications in Ambient Assisted Living and assistive diagnosis for complex technical devices. In these scenarios, the underlying models are typically large, though not overly complex in their structure. The main consideration is therefore scalability with respect to the size of the domain model; to effectively support humans or to avoid consequential damage to machinery, information processing is subject to soft real-time constraints.

The solution proposed is based upon logic-based abduction which is not the only, but probably the best-studied notion of this type of inference (see [Paul1993] for a survey). In logic-based reasoning, model, observations and hypotheses are represented and manipulated using formal logics; description logics were chosen as a representation language due to their decidability. Since logic-based abduction is known to be at least as hard as deduction, the underlying description logic obviously has to be polynomial for subsumption checking. Existential quantification may be of greater importance than universal quantification, the approach presented is in particular based on the lightweight description logic EL.

Choosing a lightweight description logic, however, does not necessarily guarantee tractability of abduction since the so-called support selection task common to all forms of goal-directed reasoning renders hypotheses generation NP-hard even for Horn-theories (see [Selman1990]). This hardness can only be alleviated if the number of hypotheses is bound polynomially allowing (under certain conditions) to generate a single preferred hypothesis in PTIME for EL and EL⁺ knowledge bases (see [Bienvenu2008]).

The following will be directed to some basics on description logics and abduction. Next, a formalism will be introduced and its tractability is illustrated. Then, a scenario is provided that illustrates how the diagnosis problem can be solved.

### Preliminaries

Description logics are a family of logic-based knowledge representation formalisms designed to ensure decidability of standard reasoning tasks. A concrete description logic is characterized by its admissible concept constructors and axiom types, typically constituting a tradeoff between expressivity and computational complexity. The EL family of lightweight description logics (see, e.g., [Baader2005a]) was tailored specifically to tractability, resulting in a language combining PTIME decidability of standard reasoning tasks with adequate expressivity for modeling, e.g., the biomedical ontology SNOMED CT.

The following table summarizes the constructs available in EL for defining concepts and axioms based on a set N_{C} of concept names and a set N_{R} of role names:

| Syntax | Semantics |
|---|---|
| T | Δ^{x} |
| C [symbol] D | C [symbol] ∩ D^{x} |
| ∃r.C | {x ∈ Δ^{x} \| ∃_{y} ∈ Δ^{x}: (x,y) ∈ r^{x} [symbol] y ∈ C [symbol] } |
| C [symbol] D | C [symbol] ⊂ D^{x} |
| C ≡ D | C^{x} = D^{x} |

It may be assumed that a knowledge base [symbol] is in normal form, containing only general concept inclusion axioms of the form
A₁ [symbol] A₂ [symbol] B (i.e. “if an object belongs to class A₁ and to class A₂, then it also belongs to class B”, or for short “A₁ and A₂ implies B”);
A₁ [symbol] ∃r·B (i.e. “if an object belongs to class A, then it is connected to at least one object of class B via the relation r”) and
∃r·A₁ [symbol] B (i.e. “if an object is connected to at least one object of class A₁ via the relation r, then it belongs to class B”),
with rεN_{R}, A₁, A₂, BεN_{C}∪{T}.

For the complete EL family, normalization of an axiom set is linear in the number of axioms both concerning the time required and the number of new axioms generated.

Axiom pinpointing, which provides a basis for the approach presented, can be seen to extend subsumption checking by determining sets S [symbol] of axioms such that the axioms in each set provide a justification for a given subsumption

C [symbol] D (i.e. S [symbol] C [symbol] D).

While this non-standard inference task provides useful information in case [symbol] C [symbol] D (i.e. if “C implies D” is logically entailed by the theory [symbol] ), it necessarily fails if [symbol] C [symbol] D (i.e. if “C implies D” is NOT logically entailed by theory [symbol] ). In this latter situation, abductive inference offers a solution by determining sets of hypotheses [symbol] compatible with [symbol] that justify the observation if added to the knowledge base, i.e.
[symbol] ∪ [symbol] ⊥ (i.e. [symbol] and [symbol] taken together are NOT inconsistent and/or contradictory) and
[symbol] ∪ [symbol] C [symbol] D) (i.e. “C implies D” is logically entailed by the [symbol] and [symbol] taken together).

Due to the restriction of EL to terminological information, a so-called TBox abduction is considered, where both observations and hypotheses are represented by concept inclusion axioms. This means that no so-called individuals (instances of concepts) are considered; instead, information is processed solely on the level of concept descriptions.

Tbox abduction can be deemed based on [Colucci2003] which determines, given a knowledge base [symbol] and two concepts C and D), a concept H such that
[symbol] C [symbol] H≡⊥ (i.e. “C and H are not contradictory, given the information in [symbol] ”) and
[symbol] C [symbol] H [symbol] D (i.e. “C restricted by H is a sub-concept (or: ‘implies’) D, given the information in [symbol] ”).

This approach as well as the more elaborate notion of structural abduction according to [DiNoia2009] employs a tableaux-based calculus for finding a single, [symbol] -optimal explanation and is thus less flexible than the approach defined here.

In order to obtain a tractable algorithm for abductive reasoning within description logics, reference is made to previous work on automata-based axiom pinpointing for EL (see [Baader2008b] or [Penaloza2009]).

The proposed method is based on encoding the model into a weighted Büchi automaton comprising accepting runs (called behavior) that represent all derivations of the observation from domain knowledge and abducible information, the latter of which is defined compactly using patterns. A hypothesis formula encoding this set of explanations can be determined in PTIME with respect to the size of the knowledge base. The upcoming section presents the details of the solution provided.

### Automata-Based Abduction for EL

Next, the abductive framework will be illustrated. It differs from other approaches in that both the observation to be explained and the abducibles are general concept inclusion axioms. This appears to be a beneficial way to express relationships between domain elements in EL, e.g., because of the absence of individuals. As mentioned before, the knowledge base [symbol] is assumed to be in normal form (otherwise, the normal form can be constructed).

### Definition 1: Axiom Pattern; Instantiation:

Let [symbol] be an EL-TBox over concept names N_{C} and role names N_{R},

ν^{C} a set of concept variables and

rng:ν^{C}→ [symbol] (N_{C}∪{T})

a complete function mapping each concept variable to a set of concept names (possibly including T), called its range.

The range extends by subsumption to

rng*(Vᵢ^{C})={CεN_{C}∪{T}|∃Dεrng(Vᵢ^{C}): [symbol] C [symbol] D)}
with rng(Vᵢ^{C})⊂rng*(Vᵢ^{C})
since [symbol] C [symbol] applies.

An axiom pattern is an axiom as defined in the table above (not necessarily in normal form), where concept descriptions may contain concept variables from the set of concept variables ν^{C}. An instantiation of a pattern is an axiom derived from the pattern by replacing each of its concept variables Vᵢ^{C} with an element of rng*(Vᵢ^{C}).

### Definition 2: Abduction Problem:

Let [symbol] be an EL-TBox over concept names NC and role names NR, A₀ [symbol] B₀ a general concept inclusion in normal form such that A₀, B₀εN_{C} (called an observation), and Pat a set of axiom patterns over ν^{C} which size is polynomially bounded by the number of concept names in N_{C}, and rng a range function. The tuple

[symbol]

=( [symbol] ,A₀ [symbol] B₀,Pat,ν^{C},rng)

is called an abduction problem.

Concept patterns and range function allow for a fine-grained definition of the parts of the domain which may be assumed. This proves valuable in large-scale applications where typically most of the domain is considered to be fixed (and assumptions most presumably contradict reality), while only certain types of axioms are likely to represent missing information. As an example, compositional (part Of) hierarchies of technical systems may be known to the constructor, whereas the set of observations about such a system is much more likely to be incomplete.

Furthermore, explanations are typically required to be non-trivial (see [Paul1993]), in particular a piece of information must not be explained by itself. This can be achieved easily by selecting appropriate axiom patterns and concept variable ranges. As side-effect, restricting the set of abducibles cuts the search space and the number of hypotheses generated and may therefore increase efficiency.

It is noted that the limitation of the size of Pat in Definition 2 may be required to ensure a polynomial worst-case complexity of the algorithm.

### Definition 3: Abducible

Given the abduction problem [symbol] =( [symbol] , A₀ [symbol] B₀, Pat, ν^{C}, rng), the set of abducibles Abd [symbol] contains all axioms generated by normalizing the elements of the set of axiom patterns Pat and instantiating them with concept names from the range rng, omitting axioms already contained in the EL-Tbox [symbol] .

Let N_{C′} denote a set of concept names N_{C} extended by new concept names introduced during normalization.

### Definition 4: Labeling Function

Given the abduction problem [symbol] =( [symbol] , A₀ [symbol] B₀, Pat, ν^{C}, rng), it is assumed that each axiom ax in the EL-Tbox [symbol] and each abducible abd in the set of abducibles Abd [symbol] is labeled with a unique propositional variable lₐₓ and l_{abd}, respectively, such that the sets of axiom labels and abducible labels are disjoint.

The labeling function lab then assigns a label to each general concept inclusion gci as follows: If the general concept inclusion gci is an axiom (abducible), then lab(gci) is a predefined propositional variable lₐₓ (l_{abd}). Otherwise, if the general concept inclusion gci is a tautology of the form A [symbol] A [symbol] A or A [symbol] A [symbol] T, lab(gci) can be set to the top (i.e. lab(gci)=T; in all other cases: lab(gci)=⊥.

Also, lab( [symbol] ) denotes a set of all labels occurring in the abduction problem.

To simplify the notation, a propositional valuation ν is identified with the set of variables it assigns to be true. Also, [symbol] _{ν}={axε [symbol] |lab(ax)εν} denotes a restriction of an axiom set [symbol] to the axioms made true by ν. This definition can be extended to axiom problems applying [symbol] _{ν}=( [symbol] ∪Abd [symbol] )|ν.

### Definition 5: Hypotheses Formula

A hypotheses formula for the abduction problem [symbol] =( [symbol] , A₀ [symbol] B₀, Pat, ν_{C}, rng) is a monotone Boolean formula η [symbol] over the labeling function lab( [symbol] ) such that for all valuations ν⊂lab( [symbol] ) the following applies:

ν [symbol] η [symbol] iff [symbol] _{ν} [symbol] A₀ [symbol] B₀.

Hence the valuation ν makes the hypotheses formula η [symbol] become TRUE if the abduction problem limited to axioms, which labels are set by ν to TRUE, fulfills the observation A₀ [symbol] B₀.

Abductive inference on the original knowledge base [symbol] can thus be expressed as a pinpointing problem in the extended problem space [symbol] ∪Abd [symbol] . Hence, an abductive automaton can be defined employing the approach proposed in [Penaloza2009].

### Definition 6: Abductive Automaton; Behavior

An abductive automaton for the abduction problem [symbol] =( [symbol] , A₀ [symbol] B₀, Pat, ν^{C}, rng) is a weighted Büchi automaton [symbol] ={Q, wt, in, F} over binary trees with
Q={(A, B), (A, r, B)|A, BεN_{C′}∪{T}, rεN_{R};
∀A, B, B₁, B₂εN_{C′}∪{T}, ∀rεN_{R};
   wt((A, B), (A, B₁), (A, B₂)=lab(B₁ [symbol] B₂ [symbol] B);
   wt((A, r, B), (A, B₁), (A, A)=lab(B₁ [symbol] ∃r·B);
   wt((A, B), (A, r, B₁), (B₁, B₂)=lab(∃r·B₂ [symbol] B);
   wt((q₁, q₂, q₃)=⊥ for all other q₁, q₂, q₃εQ;
in(q)=T iff q=(A₀, B₀), otherwise in(q)=⊥, and
F={(A, A)|AεN_{C′}∪{T}},
   where Q denotes a set of states, F⊂Q a set of terminal states, in an initial distribution, and wt transition weights of the Büchi automaton [symbol] .

The definition of the transition weights wt can be extended to a complete run

ti \vec{r}=q₁ . . . qₙ

as

wt(\vec{r})=wt(q₁) [symbol] . . . [symbol] wt(qₙ),

wherein succ(q) can be a set of all successful runs of the Büchi automaton [symbol] starting in state q. The behavior of the Büchi automaton [symbol] can be defined by

[symbol]

_{qEQ}(in(q) [symbol] _{\vec{r}εsucc(q)}wt(\vec{r})).

As there is exactly one state q having in(q)≠⊥, namely (A₀, B₀), the behavior of the Büchi automaton [symbol] is the disjunction of the weights of all its successful runs starting in (A₀, B₀).

Due to the specification of the transition weights, each run corresponds to a derivation of A₀ [symbol] B₀. Intuitively, the weight wt attributes triples (q₁, q₂, q₃) of states with provenance information regarding the derivation of q1 from q2 and q3: Trivial derivation steps (such as q₁=(A, T) or q₁=q₂=q₃ are labeled with the symbol T due to Definition 4; the weight of a non-trivial step is the label of an axiom and/or abducible such that q1 can be deduced from q2 and q3 using this axiom and/or abducible (or ⊥ if none exists).

As an example, the definition

wt((A,B),(A,B₁),(A,B₂))=lab(B₁ [symbol] B₂ [symbol] B)

expresses that, given A [symbol] B₁ and A [symbol] B₂, A [symbol] B can be derived in case B₁ [symbol] B₂ [symbol] B is known.

### Theorem 1:

For a given abduction problem [symbol] =( [symbol] , A₀ [symbol] B₀, Pat, ν^{C}, rng), a behavior of the abductive automaton [symbol] is a hypotheses formula for the observation A₀ [symbol] B₀.

Hence, the abductive automaton of Definition 6 can be used to determine the hypotheses formula of Definition 5.

If the set of axiom patterns is empty (i.e. Pat=φ), the abductive automaton and hypotheses formula defined before coincide with the notions of pinpointing automaton and pinpointing formula due to the empty space of abducibles. If the set of abducibles Abd [symbol] is nonempty, the abductive automaton [symbol] can be interpreted as a pinpointing automaton for TBox [symbol] ′= [symbol] ∪Abd [symbol] as noted before.

Details on how to compute behavior of an automaton can be obtained from [Baader2008b] or [Baader2009].

Pursuant to the setting introduced above this can even be done efficiently based on the following theorem.

### Theorem 2:

For a given abduction problem [symbol] =( [symbol] , A₀ [symbol] B₀, Pat, ν^{C}, rng) computing the hypotheses formula η [symbol] takes polynomial time in the size of the knowledge base [symbol] .

For a given abduction problem [symbol] =( [symbol] , A₀ [symbol] B₀, Pat, ν^{C}, rng), N_{C} and N_{R} are the sets of the concept names and the role names within the knowledge base [symbol] N_{C}, is the extended set of concept names including the new names generated during normalization of the axiom patterns in Pat. The abductive automaton [symbol] can be regarded as a pinpointing automaton for the extended problem space [symbol] ∪Abd [symbol] , whose behavior can be computed with an algorithm that is polynomial in the number of states of the automaton as shown in [Penaloza2009].

Following the construction given in Definition 6, the abductive automaton [symbol] has
(₂^{|N}^{_{C′}}^{|+1}) states of type (A, B) and
(₂^{|N}^{_{C′}}^{|+1}) states of type (A, r, B),
   which is polynomial in N_{C′} and N_{R}. To show that the number of states is also polynomially bounded in N_{C}, i.e. the number of concept names before normalization (and not only in N_{C′}, the number of concept names after normalization), the fact is used that the number of new concept names introduced by normalizing a set of axioms is linear in the size of this axiom set. Therefore, the following applies for a constant c which can be chosen independently from N_{C}:

|N_{C′}|≦|N_{C}|+c·|Pat|

Since the number of axiom patterns is polynomially bounded by the size of the names N_{C} (see Definition 2), there exists a polynomial boundary regarding the size of N_{C′}, and therefore also with regard to the size of the abductive automaton [symbol] .

It is noted that the size of the abductive automaton and thus the complexity of the proposed approach are independent of the number of concept variables used since variables cannot induce new concept names (and thus states in the abductive automaton [symbol] .

In assistive diagnosis, it is often convenient to be able to compare explanations of different, competing diagnoses (called differential diagnosis in medicine). The abduction method proposed herewith naturally meets this demand, as the only part of the automaton that depends on the observation A₀ [symbol] B₀ is the initial distribution in. To derive the hypotheses formula for a different observation A₁ [symbol] B₁, the complete automaton [symbol] can be re-used without any modification to determine the successful runs starting in (A₁, B₁).

The hypotheses formula generated by the automaton [symbol] can be interpreted as follows: The hypotheses formula η [symbol] compactly encodes all possible derivations of A₀ [symbol] B₀ with regard to the knowledge base [symbol] and the set of abducibles [symbol] . An explicit representation of the set of hypotheses can be derived in a straightforward manner by transforming the hypotheses formula η [symbol] into disjunctive normal form, each clause representing a single hypothesis. This approach is not optimal since it may lead to an exponential blowup, a real-world system should therefore directly present, interpret and manipulate the compact representation of the hypotheses formula η [symbol] whenever possible. It is noted that that the hypotheses formula η [symbol] carries information on both necessary assumptions and axioms required justifying A₀ [symbol] B₀.

The proposed solution can therefore be seen to integrate and complement axiom pinpointing by allowing inferring reasons for unwanted entailments to hold as well as for expected subsumptions not to hold. This provides additional capabilities which may be useful among others for ontology debugging and refactoring. If only necessary assumptions are required, but not in their interactions with the axioms from the domain model, the approach can easily be adapted by adding only labels for abducibles to the hypotheses formula η [symbol] , leading to a significantly more compact hypotheses formula η [symbol] .

### Exemplary Use Case Scenario:

This section illustrates the proposed approach by applying it to a use case in industrial diagnosis. Real-world models in this scenario typically consist of thousands of components and subcomponents, for most of which certain symptoms can be observed or determined indicating possible failure states of the system or a portion thereof.

Oftentimes, a causal structure of the domain of the system is at least partially unknown, models for diagnosis therefore have to be built on experience, relating sets of symptoms to diagnoses determined by a technician checking the system.

As an example, the scenario provides an assistive diagnosis, using sensor data and observations made by maintenance personnel to interactively diagnose the system by actively requesting missing observations.

For this exemplary scenario, a CNC lathe is considered comprising two components surveyed by sensors: An axle motor and an oil pump of the motor cooling system. Sensors mounted at the axle motor can recognize vibrations and increased temperature, the monitored parameters for the oil pump include the actual voltage. It is assumed that the measurements of these sensors are sufficient to recognize two different failure states, i.e.
an untrue axle (characterized by vibrations and high axle motor temperature) and
a power failure in the axle cooling system (defined by an overheating motor and low oil pump voltage).

A system having an axle cooling failure can, e.g., be represented by the following EL axiom:

∃hasComp·(AxleMotor [symbol] ∃hasSymp·HiTemp) [symbol] ∃hasComp·(OilPump [symbol] ∃hasSymp·LowVoltage) [symbol] ∃hadDing·AxleCoolFail

In other words, given a system being observed, the axle motor showing as a symptom (“hasSymp”) a high temperature together with the oil pump showing as a symptom (“hasSymp”) a low voltage are enough to conclude that the system has a cooling failure of the axle (indicated as diagnosis “hasDiag”).

Normalizing the axiom results in the normal form axioms (which corresponds to the knowledge base in normal form):

Has_{HotAm}^{Comp} [symbol] Has_{DeadOP}^{Comp} [symbol] System_{ACF} (1)

∃hasComp·HotAM [symbol] Has_{HotAM}^{Comp} (2)

AxleMotor [symbol] Has_{HiTemp}^{Symp} [symbol] HotAM (3)

∃hasSymp·HiTemp [symbol] Has_{HiTemp}^{Symp} (4)

∃hasComp·DeadOP [symbol] Has_{DeadOP}^{Symp(}5)

OilPump [symbol] Has_{LowVoltage}^{Symp} [symbol] DeadOP (6)

∃hasSymp·LowVoltage [symbol] Has_{LowVoltage}^{Symp} (7).

A new concept name System_{ACF} is defined by

System_{ACF}≡∃hasDiag·AxleCoolFail

In case of an untrue axle, the second diagnosis considered in this example, can be defined and normalized analogously, leading to the following additional EL axioms in normal form:

Has_{HotAm}^{Comp} [symbol] Has_{VibratAM}^{Comp} [symbol] System_{UA} (8)

∃hasComp·VibratAM [symbol] Has_{VibratAM}^{Comp} (9)

AxleMotor [symbol] Has_{Vibrations}^{Symp} [symbol] VibratAM (10)

∃hasSymp·Vibrations [symbol] Has_{Vibrations}^{Symp} (11).

Having specified general (terminological) knowledge about the dependencies of certain symptoms and diagnoses, the concrete system can be formalized denoted by System_{Obs}, for which both an increased axle temperature and a low voltage in the system for pumping the oil used to cool the axle motor are measured:

System_{Obs} [symbol] ∃hasComp·AxleMotor_{Obs} (12)

System_{Obs} [symbol] ∃hasComp·OilPump_{Obs} (13)

AxleMotor_{Obs} [symbol] AxleMotor (14)

AxleMotor_{Obs} [symbol] ∃hasSymp·HiTemp (15)

OilPump_{Obs} [symbol] OilPump (16)

OilPump_{Obs} [symbol] ∃Symp·LowVoltage (17).

In case maintenance personnel wants to compare explanations for the diagnoses “untrue axle” and “axle cooling failure” to decide on further diagnostic or corrective steps, two target (or terminal) states can be derived:

q₀=(System_{Obs},System_{ACF}) (a)

and

q₁=(System_{Obs},System_{UA}) (b)

wherein “UA” indicates an untrue axle and “ACF” indicates an axle cooling failure.

For these both target states (a) and (b) the hypotheses formula may be determined independently using the same abductive automaton [symbol] (with a modified definition of the initial distribution in). Regarding the space of abducibles, the physical structure of the system can be regarded fixed and only allow for symptoms to be assumed. This can be achieved by defining the pattern

Pat={V_{Comp} [symbol] ∃hasSymp·V_{Symp}}

with a range amounting to

rng(V_{Comp})=Component

and

rng(V_{Symp})=Symptom.

The number of concept inclusions in the set of abducibles Abd [symbol] is too large for an extensive listing even in this simple case, so the presentation can be limited to one axiom in Abd [symbol] required to form a hypothesis for the diagnosis of an untrue axle, i.e.:

AxleMotor_{Obs} [symbol] ∃has Symp·Vibrations (18)

For the same reason, the complete automaton [symbol] cannot be represented.

FIG. 1 shows an excerpt containing one successful run for each diagnosis under consideration. The two runs actually correspond to the most natural hypotheses in terms of requiring the least number of assumptions to be made. Rectangles represent states, wherein input states are illustrated by the reference “INP” and terminal states are illustrated by the reference “TERM”. The remaining states are regular states.

The label “T” indicates a tautology label T, the labels “1” to “17” represent axiom labels and the label “18” indicates an abducible. Identical sub-trees are merged in FIG. 1.

The weights of the runs from the two input nodes (System_{Obs}, System_{ACF}) and (System_{Obs}, System_{UA}) to the terminal (leaf) nodes represent two partial hypotheses formulas for the diagnoses AxleCodingFailure (ACF) and UntrueAxle (UA), i.e.:

η_{ACF}^{part}=1 [symbol] (5 [symbol] 13 [symbol] (6 [symbol] (16 [symbol] T) [symbol] (7 [symbol] 17))) [symbol] (2 [symbol] 12 [symbol] (3 [symbol] (14 [symbol] T) [symbol] (4 [symbol] 15)))

η_{UA}^{part}=8 [symbol] (2 [symbol] 12 [symbol] (3 [symbol] (14 [symbol] T) [symbol] (4 [symbol] 15))) [symbol] (9 [symbol] 12 [symbol] (10 [symbol] (14 [symbol] T) [symbol] (11 [symbol] 18)))

Comparing the two hypotheses, it shows that neither of them is clearly better than the other: On the one hand, an axle cooling failure is justified by the observations alone (requiring no assumptions to be made), yet it postulates faults in two distinct components. On the other hand, an untrue axle can be diagnosed locally for one component, it however requires the assumption of general concept inclusion axiom 18.

### FURTHER EMBODIMENTS AND ADVANTAGES

The present solution realizes TBox abduction in the lightweight description logic EL based on a novel reduction to axiom pinpointing in PTIME. The approach is applicable in an industrial diagnosis scenario. Given a knowledge base and a concept inclusion representing the observation to be explained, the procedure determines a hypotheses formula that compactly encodes all explanations with respect to a pattern-based representation of the abducible part of the domain model. The remainder of the model is considered to be fixed in accordance with the scenario. The proposed reduction of abductive inference to axiom pinpointing exploits the duality of the two tasks: Whereas the latter addresses the problem of explaining why a certain unwanted subsumption is entailed by the ontology, the solution presented determines the reason for an expected subsumption not to hold, expressed in terms of additions to the domain model necessary to actually make it hold.

This approach can be extended as follows: Since role inclusion axioms and nominals are frequently used in diagnostic models, it is favorable (and feasible) to include such constructs to extend the logical expressivity as much as possible without sacrificing tractability. Additionally, including quantitative information into the model allows for weighting hypotheses and can eventually be used as a criterion for guiding hypothesis generation. Finally, extending minimality criteria for single hypotheses to sets of hypotheses compactly represented by a hypothesis formula will allow us to efficiently infer common effects.

FIG. 2 shows a block diagram comprising steps of the method suggested herein. In a step 201, a pattern-based definition of abducibles is determined and in a step 202, based on these abducibles, an abduction problem is solved.

FIG. 3 shows a block schematic comprising a control device 301 that is deployed with an industrial system 302 and a control device 303 that is connected to the industrial system 302 via a network 305, e.g., the Internet. Both control devices 301, 303 can be used to control said industrial system 302, in particular to provide diagnoses for the industrial system 302 and/or setting/adjusting the parameters of the industrial system 302.

### REFERENCES

[Appelt1992] Appelt, Douglas E. and Pollack, Martha E.: Weighted Abduction for Plan Ascription. In: User Modeling and User-Adapted Interaction, Volume 2, Number 1-2. (Springer, 1992). Pages 1-25. Issn: 0924-1868. (http://citeseerx.ist.psu.edu/viewdoc/summary?doi=10.1.1.41.9063)
[Baader2005a] Baader, Franz and Brandt, Sebastian and Lutz, Carsten: Pushing the EL Envelope. In: Proceedings of the 19th International Joint Conference on Artificial Intelligence (IJCAI 2005). (Professional Book Center, 2005). Pages 364-369. Isbn: 0938075934. (http://www.ijcai.org/papers/0372.pdf)
[Baader2008b] Baader, Franz and Penaloza, Rafael: Automata-Based Axiom Pinpointing. In: Proceedings of the 4th International Joint Conference on Automated Reasoning (IJCAR 2008, Volume 5195). (Springer, 2008). Pages 226-241. Isbn: 978-3-540-71069-1
[Baader2009] Franz Baader and Rafael Penaloza: Automata-based Axiom Pinpointing. In: Journal of Automated Reasoning, Special Issue: IJCAR-2008. (2009)
[Bienvenu2008] Bienvenu, Meghyn: Complexity of Abduction in the EL Family of Lightweight Description Logics. In: Proceedings of the 11th International Conference on Principles of Knowledge Representation and Reasoning (KR 2008). (AAAI Press, 2008). Pages 220-230. Isbn: 978-1-57735-384-3. (http://www.aaai.org/Papers/KR/2008/KR08-022.pdf)
[Colucci2003] Colucci, Simona and Di Noia, Tommaso and Di Sciascio, Eugenio and Donini, Francesco M. and Mongiello, Marina: Concept Abduction and Contraction in Description Logics. In: Proceedings of the 16th International Workshop on Description Logics (DL 2003), Volume 81. (CEUR-WS.org, 2003). (http://SunSITE.Informatik.RWTH-Aachen.de/Publications/CEURWS/Vol-81/donini.pdf)
[DiNoia2009] Di Noia, Tommaso and Di Sciascio, Eugenio and Donini, Francesco M.: A Tableaux-Based Calculus for Abduction in Expressive Description Logics: Preliminary Results. In: Proceedings of the DL Home 22nd International Workshop on Description Logics (DL 2009), Volume 477. (CEUR-WS.org, 2009). (http://ceur-ws.org/Vol-477/paper 52.pdf)
[Hobbs1993] Hobbs, Jerry R. and Stickel, Mark E. and Appelt, Douglas E. and Martin, Paul A.: Interpretation as Abduction. In: Artificial Intelligence, Volume 63, Number 1-2. (Elsevier, 1993). Pages 69-142. (http://citeseerx.ist.psu.edu/viewdoc/summary?doi=10.1.1.41.679)
[Paul1993] Paul, Gabriele: Approaches to Abductive Reasoning: An Overview. In: Artificial Intelligence Review, Volume 7, Number 2. (Springer, 1993). Pages 109-152. Issn: 0269-2821. (http://citeseerx.ist.psu.edu/viewdoc/summary?doi=10.1.1.51.3821)
[Penaloza2009] Penaloza, Rafael: Using Tableaux and Automata for Pinpointing in EL. In: Proceedings of the {TABLEAUX 2009} Workshop on Tableaux versus Automata as Logical Decision Methods (AutoTab 2009). (2009)
[Peraldi2007] Peraldi, Irma Sofia Espinosa and Kaya, Atila and Melzer, Sylvia and Möller, Ralf and Wessel, Michael: Towards a Media Interpretation Framework for the Semantic Web. In: Proceedings of the 2007 IEEE/WIC/ACM International Conference on Web Intelligence (WI 2007). (IEEE Computer Society, 2007). Isbn 0-7695-3026-5. (http://www.sts.tuharburg.de/papers/2007/PKMMW07.pdf)
[Selman1990] Selman, Bart and Levesque, Hector J.: Abductive and Default Reasoning: A Computational Core. In: Proceedings of the 9th National Conference on Artificial Intelligence (AAAI 1990). (AAAI Press/The MIT Press, 1991). Pages 343-348. (http://www.aaai.org/Papers/AAAI/1990/AAAI90-053.pdf)
[Shanahan2005] Shanahan, Murray: Perception as Abduction: Turning Sensor Data into Meaningful Representation. In: Cognitive Science, Volume 29, Number 1. (Science Direct, 2005). Pages 103-134. (http://www.doc.ic.ac.uk/-mpsha/CogSci05.pdf)

1-15. (canceled)

16: A method for controlling an industrial system, which comprises the steps of:
determining a pattern-based definition of abducibles; and
solving an abduction problem solved based on the pattern-based definition of abducibles.

17: The method according to claim 16, wherein the abduction problem is denoted as [symbol]
=( [symbol] ,A₀ [symbol] B₀,Pat,ν^{C},rng)
with
being an EL-TBox over concept names N_{C};
A₀ [symbol] B₀ being role names N_{R}, a general concept inclusion in normal form such that A₀B₀εN_{C} (called an observation);
ν^{C} being a set of concept variables;
Pat being a set of axiom patterns over ν^{C} whose size is polynomially bounded by a number of concept names in N_{C}; and
rng being a range function.

18: The method according to claim 17, wherein the pattern-based definition of abducibles contains a set of abducibles containing all axioms generated by normalizing elements of the set of axiom patterns and instantiating them with concept names from the range, omitting axioms already contained in the EL-Tbox.

19: The method according to claim 18, wherein each of the abducibles in the set of abducibles is labeled with a unique pro-positional variable.

20: The method according to claim 18, wherein each axiom in the EL-Tbox and each abducible in the set of abducibles is labeled with a unique propositional variable, respectively, such that sets of axiom labels and abducible labels are disjoint.

21: The method according to claim 19, wherein hypotheses are determined as formula over all labels occurring in the abduction problem such that for all valuations the following applies:
ν [symbol] η [symbol] iffA [symbol] _{ν} [symbol] A₀ [symbol] B₀
with
ν⊂lab( [symbol] ) being the valuations;
lab( [symbol] ) being a labeling function denoting a set of all labels occurring in the abduction problem; and
η [symbol] being a hypotheses formula.

22: The method according to claim 16, which further comprises solving the abduction problem via a weighted automaton.

23: The method according to claim 22, which further comprises solving the abduction problem via a weighted Büchi automaton [symbol]
={Q,ωt,in,F}
over binary trees with
Q={(A, B), (A, r, B)|A, BεN_{C′}∪{T}, rεN_{R};
∀A, B, B₁, B₂εN_{C′}∪{T}, ∀rεN_{R};
wt((A, B), (A, B₁), (A, B₂)=lab(B₁ [symbol] B₂ [symbol] B);
wt((A, r, B), (A, B₁), (A, A)=lab(B₁ [symbol] ∃r·B);
wt((A, B), (A, r, B₁), (B₁, B₂)=lab(∃r·B₂ [symbol] B);
wt((q₁, q₂, q₃)=⊥ for all other q₁, q₂, q₃εQ;
in(q)=T iff q=(A₀, B₀), otherwise in(q)=⊥, and
F={(A, A)|AεN_{C′}∪{T}},
with
Q being a set of states,
F⊂Q being a set of terminal states,
in being an initial distribution,
ωt being transition weights of the Büchi automaton [symbol] , and
N_{C} being a set of the concept names N_{C} extended by new concept names introduced during normalization.

24: The method according to claim 16, wherein the industrial system is at least partially described by a description logic.

25: The method according to claim 16, wherein the controlling includes diagnosing, adjusting, accessing or setting parameters of the industrial system.

26: The method according to claim 16, wherein the industrial system contains at least one of the following:
a machine;
a factory;
an assembly or production line;
a manufacturing site; or
an industrial application.

27: The method according to claim 16, wherein the industrial system is at least partially described by a lightweight description logic family.

28: A device, comprising:
a controlling unit for performing a method for controlling an industrial system, said controlling unit programmed to:
determine a pattern-based definition of abducibles; and
solve an abduction problem solved based on the pattern-based definition of abducibles.

29: The device according to claim 28, wherein the device is a control device of the industrial system.

30: The device according to claim 29, further comprising a network connecting said controlling unit to the industrial system.

31: The device according to claim 29, wherein said network is the Internet.

32: A system, comprising:
a device having a controlling unit for performing a method for controlling an industrial system, said controlling unit programmed to:
determine a pattern-based definition of abducibles; and
solve an abduction problem solved based on the pattern-based definition of abducibles.
